(19) United States
(12) Patent Application Publication
(10) Pub. No.: US 2025/0227020 A1
(43) Pub. Date: Jul. 10, 2025

(54) ARTIFICIAL INTELLIGENCE-DRIVEN RADIO RESET SELECTION TO MITIGATE OPERATIONAL IMPACTS

(71) Applicant: DISH Wireless L.L.C., Englewood, CO (US)

(72) Inventors: Mahdi KHANSARI, Littleton, CO (US); Mostafa TOFIGHBAKHSH, Cupertino, CA (US); Arash MAHMOUDIAN, Littleton, CO (US)

(73) Assignee: DISH Wireless L.L.C., Englewood, CO (US)

(21) Appl. No.: 18/406,826

(22) Filed: Jan. 8, 2024

(51) Int. Cl. H04L 41/0659; H04W 24/04; H04W 88/08

(52) U.S. Cl. CPC H04L 41/0661; H04W 24/04; H04W 88/08

(57) ABSTRACT

Artificial intelligence (AI)-driven radio reset selection to mitigate operational impacts is disclosed. Such an approach may minimize or avoid potentially unnecessary operational rests on the radios. This enhances the end user experience by minimizing or avoiding dropped calls and performs preventive measures instead of reactive measures. Radios are rested or cell sites are brought back to steady states before a major failure occurs.

### FIELD

The present invention generally relates to communications, and more specifically, to artificial intelligence (AI)-driven radio reset selection to mitigate operational impacts.

### BACKGROUND

From time to time, Subject Matter Experts (SMEs) of Mobile Network Operators (MNOs) or Mobile Virtual network Operators (MVNOs) are forced to rest one or more radios in Radio Access Networks (RANs) to mitigate various operational needs. For example, when a group of radios is degraded or hanged, it is not easy to know which radio is actually causing the issue. As such, the operations team rests a group of radios to force recalibration or a new start. This can lead to dropped calls and other issues. Accordingly, an improved and/or alternative approach may be beneficial.

### SUMMARY

Certain embodiments of the present invention may provide solutions to the problems and needs in the art that have not yet been fully identified, appreciated, or solved by current communications technologies, and/or provide a useful alternative thereto. For example, some embodiments of the present invention pertain to AI-driven radio reset selection to mitigate operational impacts.

In an embodiment, one or more computing systems of a carrier network include memory storing computer program instructions for an AI/machine learning (ML) observability platform and at least one processor configured to execute the computer program instructions. The computer program instructions are configured to cause the at least one processor to receive a problem description and a desired outcome for a cell site and determine an intent from the problem description and the desired outcome using an intent determination AI/ML model. The computer program instructions are also configured to cause the at least one processor to obtain data pertaining to one or more radios of the cell site and send the data to vectorizing AI/ML model trained to convert the data to vector embeddings. The computer program instructions are further configured to cause the at least one processor to receive the vector embeddings from the vectorizing AI/ML model, compare the vector embeddings to a vector database, and determine one or more radios that are a most likely cause of the problem using one or more radio problem isolation AI/ML models. Additionally, the computer program instructions are configured to cause the at least one processor to recommend resting the one or more radios or automatically rest the one or more radios.

In another embodiment, one or more non-transitory computer-readable media store one or more computer programs for an AI/ML observability platform. The one or more computer programs are configured to cause at least one processor to receive a problem description and a desired outcome for a cell site and determine an intent from the problem description and the desired outcome using an intent determination AI/ML model. The one or more computer programs are also configured to cause the at least one processor to obtain data pertaining to one or more radios of the cell site and send the data to vectorizing AI/ML model trained to convert the data to vector embeddings. The one or more computer programs are further configured to cause the at least one processor to receive the vector embeddings from the vectorizing AI/ML model, compare the vector embeddings to a vector database, and determine one or more radios that are a most likely cause of the problem using one or more radio problem isolation AI/ML models. Additionally, the one or more computer programs are configured to cause the at least one processor to recommend resting the one or more radios or automatically rest the one or more radios. The one or more radio problem isolation AI/ML models are trained to recommend a type of rest for each of the one or more radios that are the most likely cause of the problem. The resting of the one or more radios includes performing a soft rest, performing a hard rest, or both.

In yet another embodiment, a computer-implemented method for performing AI-driven radio reset selection includes receiving a problem description and a desired outcome for a cell site and determining an intent from the problem description and the desired outcome using an intent determination AI/ML model, by a computing system. The computer-implemented method also includes obtaining data pertaining to one or more radios of the cell site and sending the data to vectorizing AI/ML model trained to convert the data to vector embeddings, by the computing system. The computer-implemented method further includes receiving the vector embeddings from the vectorizing AI/ML model, comparing the vector embeddings to a vector database, and determining one or more radios that are a most likely cause of the problem using one or more radio problem isolation AI/ML models, by the computing system. Additionally, the computer-implemented method includes recommending resting the one or more radios or automatically resting the one or more radios, by the computing system. The data pertaining to the one or more radios of the cell site includes cell site coverage ranges, neighborhood relationship statistics, location data, antenna entity data, average cell availability data, uplink and downlink usage statistics, or any combination thereof.

### BRIEF DESCRIPTION OF THE DRAWINGS

In order that the advantages of certain embodiments of the invention will be readily understood, a more particular description of the invention briefly described above will be rendered by reference to specific embodiments that are illustrated in the appended drawings. While it should be understood that these drawings depict only typical embodiments of the invention and are not therefore to be considered to be limiting of its scope, the invention will be described and explained with additional specificity and detail through the use of the accompanying drawings, in which:

FIG. 1 is an architectural diagram illustrating a RAN with a 5G Open RAN (O-RAN) architecture, according to an embodiment of the present invention.

FIG. 2 illustrates a knowledge graph representing a radio of a cell in a vector database, according to an embodiment of the present invention.

FIG. 3 is an architectural diagram illustrating a telecommunications network AI/ML system, according to an embodiment of the present invention.

FIG. 4 is an architectural diagram illustrating a wireless telecommunications system, according to an embodiment of the present invention.

FIG. 5 is a flow diagram illustrating a process for performing radio reset selection to mitigate operational impacts using AI/ML, according to an embodiment of the present invention.

FIG. 6A illustrates an example of a neural network that has been trained to assist with performing radio reset selection to mitigate operational impacts, according to an embodiment of the present invention.

FIG. 6B illustrates an example of a neuron, according to an embodiment of the present invention.

FIG. 7 is a flowchart illustrating a process for training AI/ML model(s), according to an embodiment of the present invention.

FIG. 8 is an architectural diagram illustrating a computing system configured to assist with performing radio reset selection to mitigate operational impacts, according to an embodiment of the present invention.

FIG. 9 is a flowchart illustrating a process for performing radio reset selection to mitigate operational impacts, according to an embodiment of the present invention.

Unless otherwise indicated, similar reference characters denote corresponding features consistently throughout the attached drawings.

### DETAILED DESCRIPTION OF THE EMBODIMENTS

Some embodiments pertain to AI-driven radio reset selection to mitigate operational impacts. Such embodiments may minimize or avoid potentially unnecessary operational rests on the radios. This enhances the end user experience by minimizing or avoiding dropped calls and performs preventive measures instead of reactive measures. In other words, such embodiments do not wait until there is a major failure before resting the radios or bringing the cell sites back to steady states.

Radio rests are performed at cell sites only as needed in some embodiments. Soft or hard rests are performed utilizing knowledge graphs that model and represent each radio based on vector representations thereof. Real time feeds of data from the cell sites may be used to provide a holistic view by performing correlation among the cell sites. Operational data is continuously measured for the cell sites, and this data adds to the respective live feature graphs for the cell sites. The live feature graphs for neighboring cells can be used to perform correlations and to identify the most troublesome cell/radio. Radio rests are recommended or performed for the cell site that is predicted to have the most positive impact. The process may be performed iteratively until SME goals or policy goals are achieved.

Radio rests may be a more straightforward solution than performing root cause analysis in some cases. Resets force a recalibration or a new start. This can cause dropped calls and the lack of ability of callers to connect to the radio(s) that are being reset. It should be noted, however, that not all software resets have an impact on current users. For instance, resetting the authentication engine may not affect ongoing calls.

AI models may learn to represent the statistical relationships between various cell site metrics in a vector space as vector embeddings. The AI platform in some embodiments includes a vector database of real time and historic representations of cell site radios. Vector databases index, store, and provide access to structured or unstructured data alongside the vector embeddings thereof. The vector embeddings are the numerical representations of this data. Vector databases allow users to find and retrieve similar objects quickly and at scale in production environments.

Vector spaces can have tens to thousands of dimensions. The precision of the representation increases with the number of dimensions. There are different ways to represent cell site data numerically, so the same vectorizer should be used for the radios of the cell sites.

AI and machine learning (ML) allow unstructured data to be numerically represented without losing the semantic meaning thereof in the vector embeddings. Generative AI may be particularly well-suited to this task. A vector embedding is a long list of numbers, each describing a feature of the data object that the vector embedding represents. Similar objects are grouped together in the vector space. In other words, the more similar the objects are, the closer that the vector embeddings representing the objects will be to one another. Similar objects may be found using a vector search, similarity search, or semantic search. The distance between the vector embeddings may be calculated using various techniques including, but not limited to, squared Euclidean or L2-squared distance, Manhattan or L1 distance, cosine similarity, dot product, Hamming distance, etc. It may be beneficial to select the same metric that is used to train the vectorizing AI/ML model.

Vector indexing may be used to organize vector embeddings so data can be retrieved efficiently. Calculating the distance between a vector embedding and all other vector embeddings in the vector database using the k-Nearest Neighbors (kNN) algorithm can be computationally expensive if there are a large number of data points since the required calculations increase linearly (O (n)) with the dimensionality and the number of data points. It is more efficient to find similar objects using an approximate nearest neighbor (ANN) approach. The distances between the vector embeddings are pre-calculated, and similar vectors are organized and stored close to one another (e.g., in clusters or a graph) similar objects can be found faster. This process is called “vector indexing.” ANN algorithms that may be used in some embodiments include, but are not limited to, clustering-based indexing, proximity graph-based indexing, tree-based indexing, hash-based indexing, compression-based indexing, etc.

Various information may be captured in the knowledge graphs, such as coverage areas, neighbor relationship statistics, locations, antenna entities, average cell availability, uplink usage, downlink usage, etc. This data may be used to populate the vector database. The vector embeddings are then subsequently used to create the knowledge graphs that may be viewed by SMEs.

Matrices may be modeled that represent the current behavior of each radio. These matrices may represent each radio, and the vectors are different dimensions of the radio with feature representation so similarity searches can be performed for similar issues. Using these matrices, measurement methodologies and scoring methodologies may be developed to determine the likelihood that a given radio is having problems and requires a rest. The measurement and scoring methodologies may use current radio key performance indicators (KPIs) that are extrapolated from performance counters and/or faults. Feedback mechanisms are provided capturing cell site data after the rests to capture the impacts thereof and update the AI/ML models. An intent framework may be provided by RAN SMEs to describe the radio problems and the desired states. The intent framework is a suer interface where SMEs can describe policies. The policies are compiled into a set of functional elements that will monitor radios and react when certain conditions are met. Information learned during this process may be used to train and further enhance the AI/ML models. As such, the AI/ML models may continuously improve over time, as well as be adjusted for data drift and model drift.

Once trained (e.g., to perform radio problem isolation), AI/ML models can make a decision that a reset is appropriate before an issue with a radio causes it to hang. Resets may be performed in a coordinated fashion, such as stopping acceptance of new calls and sending them to another radio, forcing handoff, etc. Resets may also be performed during lower traffic times (e.g., at night) or at the anticipated lowest traffic time during a time period at the end of which the radio is expected to fail.

A correlation methodology can be based on the vectors in the vector database. If a radio required a reset in the past, when a new radio has a similar situation based on comparison of the model matrices, a reset may be forced. Radios have their own knowledge graph representations. Model matrices may be created, and if a model matrix is close enough within some metric (e.g., a number of standard deviation(s), a certain distance between vectors, etc.), then a coordinated reset is performed. If the entire cell site is rested, the traffic for the resting cell site is moved to another cell site and/or the resting cell site can stop accepting calls. If one or more radios are being rested and others are available, traffic may be moved to these radios if sufficient capacity is available. Scoring methods, likelihood of trouble, intent, etc. may make a difference.

Various radios may be used and modeled without deviating from the scope of the invention. The radios may have various Multiple Input Multiple Output (MIMO) configurations, such as 2×2, 4×2, 2×4, 4×4, 8×8, etc. MIMO configurations benefit from multiple antenna elements at the transmitter and multiple antenna elements at the receiver, where the first number of the MIMO configurations is the number of transmitting antennas and the second number is the number of receiving antennas). When a radio hangs (e.g., a Radio Unit (RU) in O-RAN), the driver may be the cause such that users cannot attach to the radio. Alternatively, the radio may be transmitting and receiving, but not connected to the baseband unit that sends to the Internet. There could also be an issue between the baseband unit and the network core. In essence, resting attempts to force reestablishment of the connection between the radio and the baseband unit in this scenario.

Such embodiments provide mobility robustness optimization (MRO). In traditional mobility management schemes, the mobile operator sets the handover parameters, which may be inefficient and inaccurate. Recently, MRO has been studied as one of the use cases in self-organization networks to reduce radio link failures (RLFs) and unnecessary handovers due to improper handover parameter settings. However, traditional handover optimization is inappropriate for different characteristics in macrocell-femtocell hybrid deployments compared with those in macrocell deployments due to the dynamic channel conditions and different mobility patterns. On one hand, the large number of femtocells makes it difficult to configure and maintain handover parameter optimization using existing schemes. On the other hand, since femtocells could be frequently turned on/off, channel conditions and neighboring cell lists change frequently.

A cost function based handover parameter optimization scheme incorporating cell load, mobile device velocity, and service type is proposed for 3GPP Long Term Evolution (LTE) macrocells. Admission control strategy and handover self-optimization are considered to optimize the handover performance. Joint hysteresis and time to trigger (TTT) optimization schemes are investigated to reduce handover failures. Most of these studies optimize the handover parameters, such as hysteresis and TTT, based on self-optimization techniques.

MRO encompasses the automated optimization of parameters affecting active mode and idle mode handovers to ensure good end-user quality and performance, while considering possible competing interactions with other Self Organizing Network (SON) features, such as automatic neighbor relation and load balancing. Incorrect handoff parameter settings can negatively affect user experience and waste network resources due to handoff failures and RLFs. While handoff failures that do not lead to RLFs are often recoverable and invisible to the user, RLFs caused by incorrect handoff parameter settings have a combined impact on user experience and network resources.

Mobile telecommunications networks include RANs and a network core. RANs belonging to 4G are known as LTE and RANs belonging to 5G are known as New Radio (NR), which has been standardized to allow tight interworking with LTE. The RAN includes antennae seen on cellular telecommunications towers and other locations (e.g., on top of buildings, in stadiums, etc.). When a cellular telephone call is made via a mobile device or a Short Message Service (SMS) message is sent, for example, antenna(s) of the RAN transmit signals to and receive signals from the mobile device. The RAN base station also digitizes the signals from the mobile device and sends this information to the network core.

In an Open RAN (O-RAN) architecture, the RAN includes three main building blocks: the Radio Unit (RU), the Distributed Unit (DU), and the Centralized Unit (CU). The RUs transmit, receive, amplify, and digitize radio frequency signals. RUs are located near, or integrated into, antenna(s) of the cellular telecommunications tower, and are operably connected to respective antenna(s). Each cellular telecommunications tower may have multiple RUs to fully service various bands for a particular coverage area. The DU receives the digitized radio signals from the RU(s) via a Cellular Site Router (CSR) that routes traffic from the RUs to the DU and sends the digitized radio signal to the CU for further processing. The DU is usually physically located at or near the RU, whereas the CU can be located nearer to the network core (e.g., in a pass-through edge data center (PEDC) or a breakout edge data center (BEDC)).

The key concept of O-RAN is “opening” the protocols and interfaces between the various building blocks (i.e., radios, hardware, and software) in the RAN. The O-RAN Alliance has defined various interfaces within the RAN, including those for fronthaul between the RU and the DU, midhaul between the DU and the CU, and backhaul connecting the RAN to the network core. The CU accommodates the higher protocol stack layers while the DU accommodates the lower protocol stack layers.

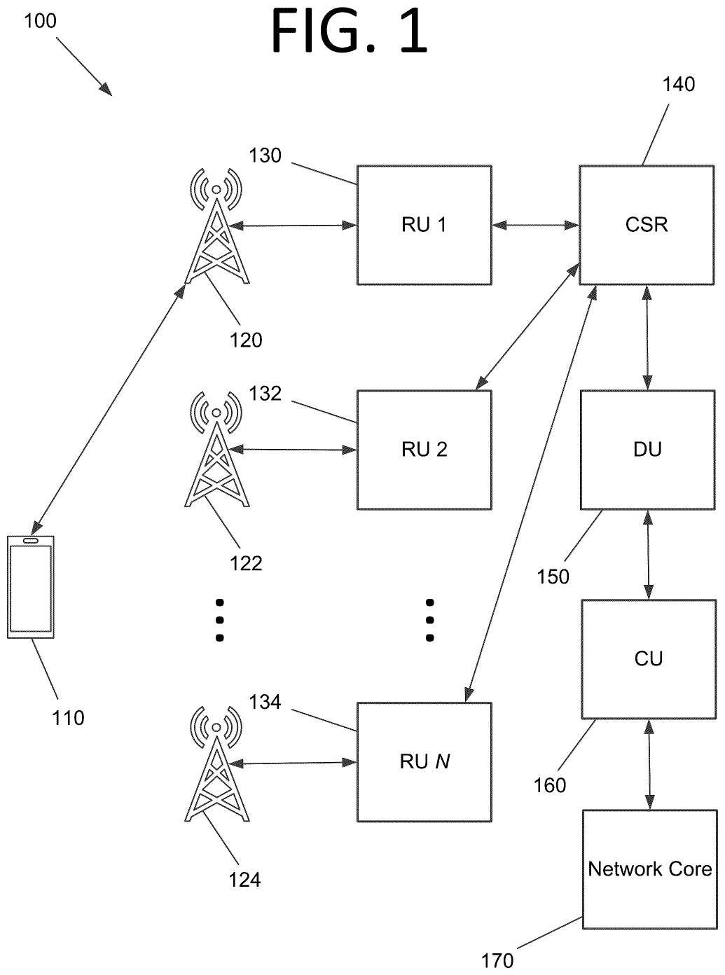

FIG. 1 is an architectural diagram illustrating a RAN 100 with a 5G O-RAN architecture, according to an embodiment of the present invention. In this case, N RUs 130, 132, 134 of a cell site are operably connected to respective antennae 120, 122, 124. Here, a mobile device 110 communicates with RU 130 via antenna 120. RUs 130, 132, 134 are in turn operably connected to a CSR 140, which routes data between RUs 130, 132, 134 and a DU 150. DU 150 is operably connected to a CU 160, which is operably connected to a network core 170. It should be noted that any desired number of DUs and/or CUs may be used without deviating from the scope of the invention. Also, the DU(s) may be operable connected to and process communications from any desired number of cell sites without deviating from the scope of the invention. Typically, there are more DUs in a RAN than CUs.

DU 150 can be offsite with respect to the cell site where RUs 130, 132, 134 are located and connected to CSR 140 by dark fiber, when available. For instance, dark fiber may connect CSR 140 to a Local Data Center (LDC) where DU 150 may be located. Alternatively, DU 150 may be located at the base of the cell site and connected to CU 160 via lit fiber. CU 160 connects to network core 170 via the wider Internet, or in some embodiments, a satellite backhaul. Network core 170 includes the AI platform and vector database.

In some embodiments, there may be multiple or many DUs per CU. The CU may be an Amazon® Web Services (AWS) Local Zone in some embodiments. From there, traffic may pass to core functions running inside an AWS Region.

The vector database and/or the AI/ML models that monitor RUs 130, 132, . . . , 134 may be located in network core 170. Alternatively, the vector database and/or the AI/ML models may be at the same location as CU 160 or DU 150. The closer the vector database and/or the AI/ML models are to RUs 130, 132, . . . , 134, the more rapidly cell site data may be captured and processed by the AI/ML models.

Knowledge graphs represent each radio and join historical data and feature behaviors. A correlation methodology is used to compare the feature graphs to find the radio that is most likely experiencing issues. The process recommends a rest or autonomously performs a rest function on the most likely troubled radio in a manner that reduces the impact on the network. KPIs and impact of the rest may be measured until the radios once again reach a steady state. The process of finding, resting, and measuring may continue until an SME is satisfied that the issue(s) have been addressed.

Poor handover-related performance may occur due to the following event categories: (1) Intra-Radio Access Technology (RAT) late handover triggering; (2) Intra-RAT early handover triggering; (3) Intra-RAT handover to an incorrect cell; Inter-RAT handover that occurs too late; and (4) Inter-RAT handover that is unnecessary. The knowledge graph abstraction can represent the handover-related features. This is enabled by graphical abstraction on a per-radio basis.

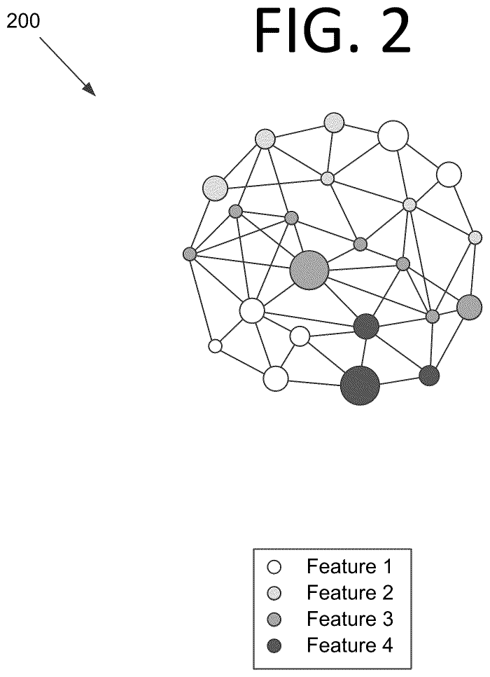

FIG. 2 illustrates a knowledge graph 200 representing features of a radio of a cell in a vector database, according to an embodiment of the present invention. Various features of the radios may be depicted, such as coverage range, neighborhood relationship statistics, location (e.g., in a coordinate system such as latitude, longitude, and potentially altitude above sea level), antenna entities (e.g., the type of each antenna, whether the antenna transmits or receives, its frequency, etc.), average cell availability, uplink and downlink usage statistics, etc. Using the knowledge graph, an SME can quickly understand from the visual characteristics thereof how a given radio of a cell is functioning.

In some embodiments, the RAN SME describes a problem to the AI/ML observability platform and describes a desired outcome. The platform compiles the intent from the SME input and captures the possible radios involved. The platform performs a set of remote diagnostics (e.g., the platform retrieves the current characteristics of the radios of a cell site) and joins the results with historical data lakes. The results of these operations are a “dataset” that is ready to be applied to the AI/ML model(s) that have been pre-trained for radio problem isolation. The AI/ML model(s) are then able to identify one or more radios that may be the cause of performance degradation or another issue at hand. For instance, the AI/ML model(s) may determine that the performance of the radio(s) is similar with a certain confidence score to that of other radios that have experienced a certain issue before. The platform then either shares the rest recommendation with the RAN SME or automatically applies a rest policy instead of performing manual rests. The results of the rest, whether manual by the RAN SME or automatic, are then evaluated by the platform as feedback and the AI/ML model(s) may be retrained over time to improve future performance.

Various advantages may be realized over existing rest strategies using the AI/ML observability platform of some embodiments. For instance, the AI/ML observability platform as a service facilitates compilation of RAN SME intents into a set of radio sites for further actions, where the knowledge graph representation of each cell site is stored in a vector database. Data model matrices may be produced by the platform that represent the current behavior of each radio. The measurement methodology and scoring methodologies that are used provide likelihoods that a troubled radio requires a rest. By measuring the outcomes of the rests, a feedback mechanism is provided that allows the AI/ML model(s) to be retrained so they become more effective over time and/or adapt to changing network conditions (e.g., due to data drift and/or model drift). Feedback regarding rests may include the radio characteristics after the rest was performed, which can be compared to the characteristics of the radio before the rest and/or to optimal radio performance characteristics. An intent framework may be provided to describe the problem and desired states by the RAN SMEs.

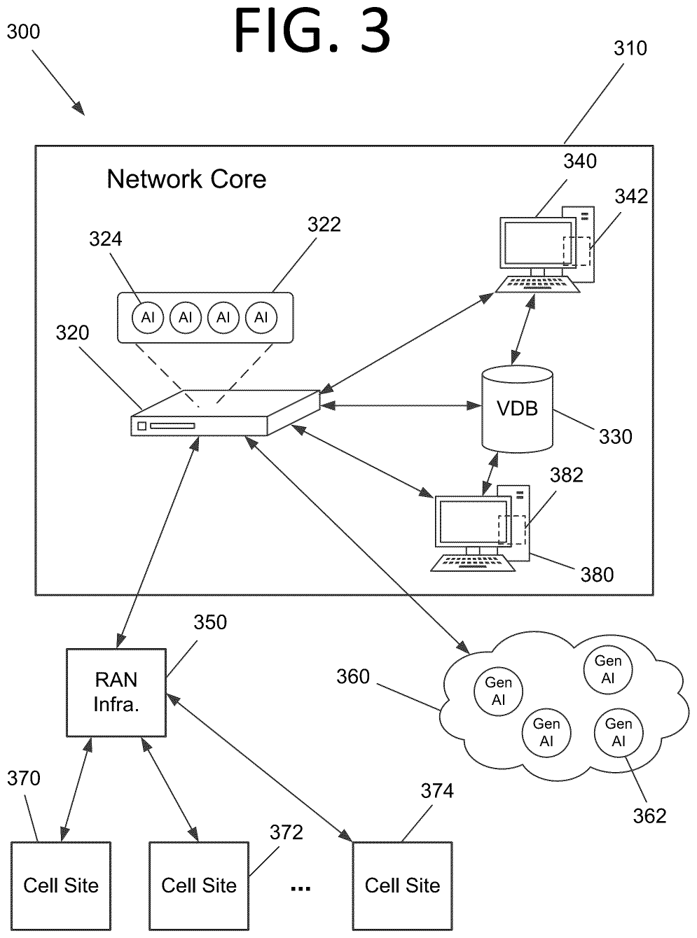

FIG. 3 is an architectural diagram illustrating a telecommunications network AI/ML system 300, according to an embodiment of the present invention. System 300 includes a network core 310. Network core 310 may include a national data center (NDC), a regional data center (RDC), a breakout edge data center (BEDC), another site housing computing systems or accessing such systems via the cloud, etc. In some embodiments, network core 310 may be network core 170 of FIG. 1.

Network core 310 includes a server 320 running an AI/ML observability platform 322 with trained AI/ML models 324. However, in some embodiments, AI/ML models 324 may be stored in a separate database accessible by server 320 and AI/ML observability platform 322. While one server 320 is shown for illustration purposes, multiple or many servers that are proximate to one another or in a distributed architecture may be employed without deviating from the scope of the invention. In some embodiments, core network 310 may incorporate or be part of a public cloud architecture, a private cloud architecture, a hybrid cloud architecture, etc. In certain embodiments, core network 310 may host multiple software-based servers on one or more computing systems, such as server 320. In some embodiments, one or more servers of core network 310, such as server 320, may be implemented via one or more virtual machines (VMs). In certain embodiments, the functionality of server 320 and/or AI/ML observability platform 322 may be implemented via Kubernetes® pods.

Radio data from cell sites 370, 372, . . . 374 is provided via RAN infrastructure 350 (e.g., Long Term Evolution (LTE) in 4G or New Radio in 5G) to AI/ML observability platform 322, which may store the data in vector database 330 or another database. AI/ML models 324 of AI/ML observability platform 322 convert this radio data into vector embeddings and store them in vector database 330, which houses the vector embeddings for the radios of cell sites 370, 372, . . . 374. Real time or near-real time cell site data may be stored in vector database 330 and used to update the vector representations of the radios of cell sites 370, 372, . . . 374.

AI/ML models 324 are trained to accomplish various tasks. For instance, AI/ML models 324 may include models trained to vectorize data from cell sites 370, 372, . . . 374 and store the vectorized data in vector database 330, compare matrices for cell site radios to one another, compare radio operations to various metrics to determine radios that are likely to fail, determine the effectiveness of radio rests, etc. AI/ML models 324 are trained using the cell site data and may be updated based on radio rest outcomes, to accommodate for data drift, to accommodate for model drift, etc. AI/ML models 324 may be trained to achieve a desired confidence threshold while not being overfit to a given set of training data. AI/ML models 324 may also be trained for any suitable purpose pertaining to monitoring radios and performing radio rests without deviating from the scope of the invention.

Two or more of AI/ML models 324 may be chained in some embodiments (e.g., in series, in parallel, or a combination thereof) such that they collectively provide collaborative output(s). Using multiple AI/ML models may allow development of a more comprehensive picture of the states of the radios, for example. Patterns may be determined individually by an AI/ML model or collectively by multiple AI/ML models. Each AI/ML model 324 is an algorithm that runs on the data, and the AI/ML model itself may be a deep learning neural network (DLNN) of trained artificial “neurons” that are trained on training data, for example. In some embodiments, AI/ML models 324 may have multiple layers that perform various functions, such as statistical modeling (e.g., hidden Markov models (HMMs)), and utilize deep learning techniques (e.g., long short term memory (LSTM) deep learning, encoding of previous hidden states, etc.) to perform the desired functionality.

In order to train AI/ML models 324, training data (labeled, unlabeled, or both) may be stored in vector database 330 or another database and provided by a training data application 342 of a training computing system 340 that can label training data. AI/ML models 324 may be initially trained using this training data, and as new training data becomes available from cell sites cell sites 370, 372, . . . 374 over time, one or more of AI/ML models 324 may be replaced with newly trained AI/ML models or be retrained to increase accuracy.

In some embodiments, generative AI models are used. Generative AI can generate various types of content, such as vector embeddings. Various types of generative AI models may be used, including, but not limited to, LLMs, generative adversarial networks (GANs), variational autoencoders (VAEs), transformers, etc. These models may be part of AI/ML models 324 hosted on server 320 in some embodiments. For instance, the generative AI models may be trained on a large corpus of information pertaining to radio operations. In certain embodiments, generative AI models 362 provided by an existing cloud ML service provider system 360, such as OpenAI®, Google®, Amazon®, Microsoft®, IBM®, Nvidia®, Facebook®, etc., may be trained to provide such functionality. Generative AI models 362 may be accessed by AI/ML observability platform 322. In generative AI embodiments where generative AI model(s) 362 are remotely hosted, AI/ML observability platform 322 can be configured to integrate with third-party APIs, which allow AI/ML observability platform 322 to send a request to generative AI model(s) 362 including the requisite input information and receive a response in return. Such embodiments may provide a more advanced and sophisticated user experience, as well as provide access to state-of-the-art AI/ML capabilities that these companies offer.

One aspect of generative AI models in some embodiments is the use of transfer learning. In transfer learning, a pretrained generative AI model is fine-tuned on a specific task or domain. This allows the generative AI model to leverage the knowledge already learned during its initial training and adapt it to a specific application. The pretraining phase involves training the generative AI model on a large corpus of information. During this phase, the generative AI model learns the relationships between elements pertaining to the cell site radios, which enables the generative AI model to represent radio characteristics and the relationships therebetween. The output of this pretraining phase is a generative AI model that has a high level of understanding of radio operating characteristics and their relationships.

In the fine-tuning phase, the pretrained generative AI model may be adapted to a specific set of cell sites, such as cell sites 370, 372, . . . 374. This allows the generative AI model to be particularly attuned to these cell sites without requiring training from scratch. By leveraging the knowledge learned in the pretraining phase, the fine-tuned generative AI model can achieve state-of-the-art performance on specific tasks with a relatively small amount of training data.

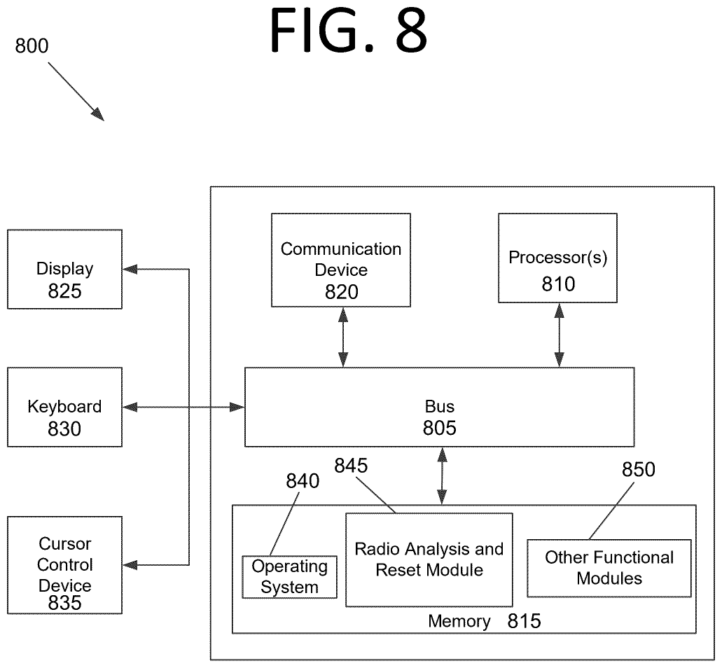

RAN SMEs may view radio characteristics using a RAN SME application 382 running on or otherwise accessible by SME computing system 380. In some embodiments, RAN SME application 382 may be remotely hosted (e.g., on server 382 as part of AI/ML observability platform 322) and accessed via a web browser. RAN SME application 382 allows the SME to describe a problem and a desired outcome. AI/ML observability platform 322 running on server 320 compiles the intent from RAN SME application 382, determines the possible radios involved, and provides this information to RAN SME application 382. The SME may view the radio operating characteristics, diagnostic information, current performance versus prior performance, etc. (e.g., in numerical or graphical format) in RAN SME application 382. AI/ML observability platform 322 may suggest radio rest(s) to the SME via RAN SME application 382, or may perform rest(s) automatically and inform the SME via RAN SME application 382. In some embodiments, server 320, computing system 340, and/or computing system 380 may be computing system 800 of FIG. 8.

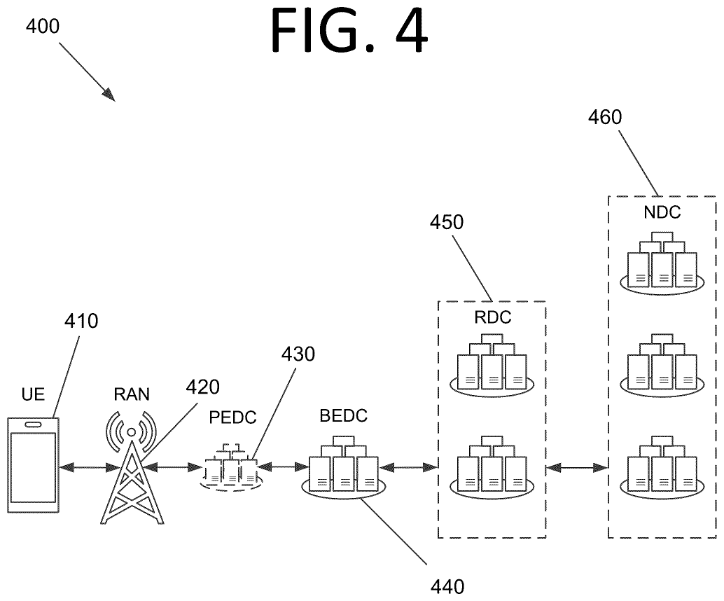

FIG. 4 is an architectural diagram illustrating a wireless telecommunications system 400, according to an embodiment of the present invention. User equipment (UE) 410 (e.g., a mobile phone, a tablet, a laptop computer, a smart watch, etc.) communicates with RAN 420. In some embodiments, RAN 420 may be a 5G New Radio O-RAN implementation where cell sites include antennas operably connected to RUs, which are operably connected to a DU, which, in turn, is operably connected to a CU.

RAN 420 sends communications to UE 410, as well as from UE 410 further into the carrier network. In some embodiments, communications are sent to/from RAN 420 via a pass-through edge data center (PEDC) 430 to provide lower latency. However, in some embodiments, RAN 420 communicates directly with a BEDC 440. In some embodiments, the DU and/or CU are located in RAN 420, PEDC 430, and/or BEDC 440. BEDCs are typically smaller data centers that are proximate to the populations they serve. BEDCs may break out User Plane Function data traffic (UPF-d) and provide cloud computing resources and cached content to UE 410, such as providing Network Function (NF) application services for gaming, enterprise applications, etc.

The carrier network may provide various NFs and other services. For instance, BEDC 440 may provide cloud computing resources and cached content to mobile device 410, such as providing NF application services for gaming, enterprise applications, etc. An RDC 450 may provide core NFs, such as UPF for voice traffic (UPF-v), UPF-d (if not in PEDC 330 or BEDC 340, for example), Session Management Function (SMF), and Access and Mobility Management Function (AMF) functionality. The SMF includes Packet Data Network Gateway (PGW) Control Plane (PGW-C) functionality. The UPF includes PGW User Data Plane (PGW-U) functionality.

An NDC 460 may provide a Unified Data Repository (UDR) and user verification services, for example. Other network services that may be provided may include, but are not limited to, Short Message Service Function (SMSF), Internet Protocol (IP) Multimedia Subsystem (IMS)+Telephone Answering Service (TAS), IP-SM Gateway (IP-SM-GW) (the network functionality that provides the messaging service in the IMS network), Enhanced Serving Mobile Location Center (E-SMLC), Home Subscriber Server (HSS), HSS+Unified Data Management (UDM), Short Message Service Center (SMSC), and/or Policy Control Function (PCF) functionality. It should be noted that additional and/or different network functionality may be provided without deviating from the present invention. The various functions in these systems may be performed using dockerized clusters in some embodiments.

BEDC 440 may utilize other data centers for NF authentication services. This helps with managing user traffic latency, for instance. However, RDC 450 may not perform NF authentication in some embodiments.

From RDC 450, NF authentication requests may be sent to NDC 460, which may be located far away from UE 410, RAN 420, PEDC 430, BEDC 440, and RDC 450. NDC 460 may provide a UDR, and user verification may be performed at NDC 460. In some embodiments, mobile device 410 and/or computing systems of RAN 420, PEDC 430, BEDC 440, RDC 450, and/or NDC 460 may be computing system 800 of FIG. 8.

It should be noted that wireless telecommunications system 400 of FIG. 4 is only one of various possible network configurations. For instance, if a cell site of RAN 420 is located in the same city as RDC 450 or no BEDC is proximate to RAN 420, RAN 420 may connect directly to RDC 450. Any suitable network configuration may be used without deviating from the scope of the invention.

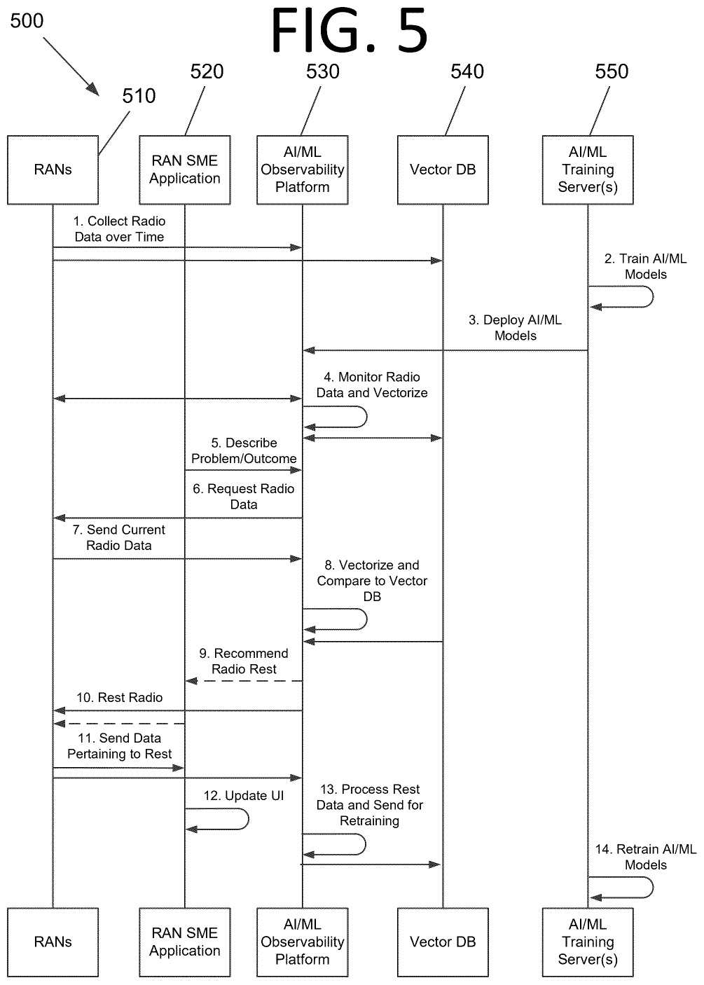

FIG. 5 is a flow diagram illustrating a process 500 for performing radio reset selection to mitigate operational impacts using AI/ML, according to an embodiment of the present invention. The process begins with collecting radio data over time from cell sites of RANs 510 by an AI/ML observability platform 530 and storing the data in a vector database 540. AI/ML training server(s) 550 then train AI/ML models using this data and deploy the trained AI/ML models to AI/ML observability platform 530.

AI/ML observability platform 530 monitors radio data from the cell sites of RANs 510 and vectorizes the data using one or more of the trained AI/ML models. An SME determines that a problem is occurring at a cell site and describes a problem and a desired outcome to AI/ML observability platform 530 via a RAN SME application 520. In some embodiments, RAN SME application 520 may be a part of AI/ML observability platform 530 and accessible by the SME via a web browser, for example.

The AI/ML observability platform 530 requests current radio data from the cell site that is experiencing the issue. The respective RAN of RANs 510 sends the radio data to AI/ML observability platform 530, which vectorizes the current radio data using a vectorizing AI/ML model and compares it to vectorized radio data in vector database 540 using other AI/ML model(s) that have been trained to perform radio problem isolation. In some embodiments, AI/ML observability platform 530 recommends resting a radio to the SME via RAN SME application 520.

AI/ML observability platform 530 or RAN SME application 520 sends instructions to the cell site and rests the radio. In some embodiments, the radio problem isolation AI/ML model(s) are trained to recommend a type of rest for of the radio(s) that are the most likely cause of the problem. The resting of the radio(s) includes performing a soft rest, performing a hard rest, or both. Data pertaining to cell site performance during the rest process and radio performance after the rest process is sent to RAN SME application 520 and AI/ML observability platform 530. RAN SME application 520 updates its user interface (UI), and AI/ML observability platform 530 processes the rest data and sends the data to vector database 540 or some other database to be used for retraining the AI/ML models. AI/ML training server(s) 550 then retrain the AI/ML models using this data and rest data from other cell site rests.

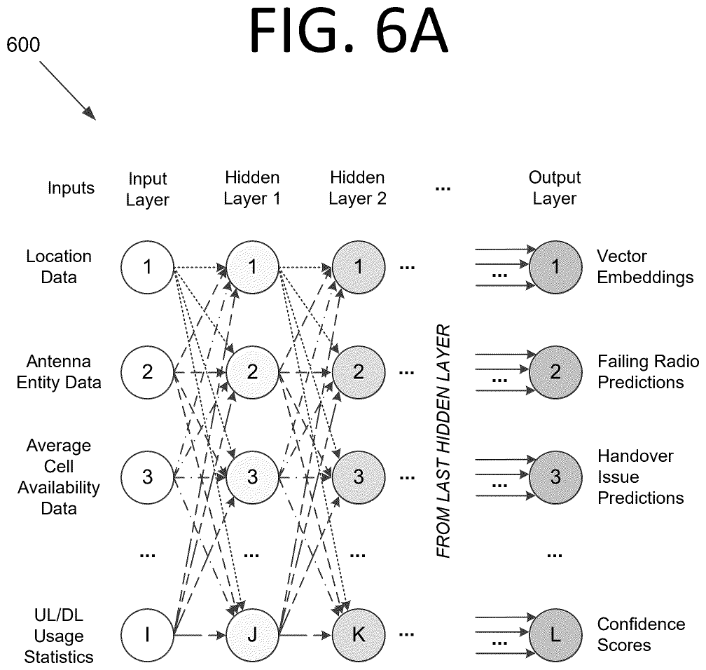

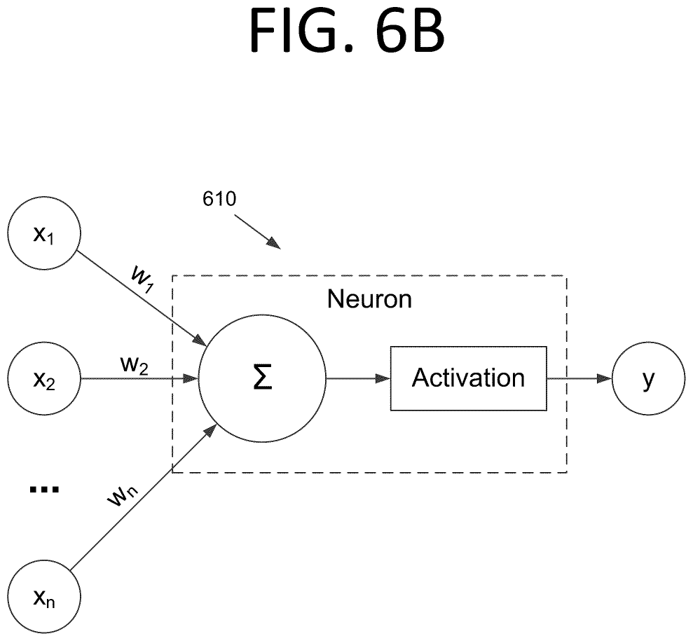

Per the above, AI/ML may be used in some embodiments. Various types of AI/ML models may be trained and deployed without deviating from the scope of the invention. For instance, FIG. 6A illustrates an example of a neural network 600 that has been trained to assist with performing radio reset selection to mitigate operational impacts, according to an embodiment of the present invention.

Neural network 600 includes a number of hidden layers. Both deep learning neural networks (DLNNs) and shallow learning neural networks (SLNNs) usually have multiple layers, although SLNNs may only have one or two layers in some cases, and normally fewer than DLNNs. Typically, the neural network architecture includes an input layer, multiple intermediate layers, and an output layer, as is the case in neural network 800.

A DLNN often has many layers (e.g., 10, 50, 200, etc.) and subsequent layers typically reuse features from previous layers to compute more complex, general functions. A SLNN, on the other hand, tends to have only a few layers and train relatively quickly since expert features are created from raw data samples in advance. However, feature extraction is laborious. DLNNs, on the other hand, usually do not require expert features, but tend to take longer to train and have more layers.

For both approaches, the layers are trained simultaneously on the training set, normally checking for overfitting on an isolated cross-validation set. Both techniques can yield excellent results, and there is considerable enthusiasm for both approaches. The optimal size, shape, and quantity of individual layers varies depending on the problem that is addressed by the respective neural network.

Returning to FIG. 6A, cell site coverage ranges, neighborhood relationship statistics, location data, antenna entity data, average cell availability data, uplink and downlink usage statistics, etc. provided as the input layer are fed as inputs to the J neurons of hidden layer 1. While all of these inputs are fed to each neuron in this example, various architectures are possible that may be used individually or in combination including, but not limited to, feed forward networks, radial basis networks, deep feed forward networks, deep convolutional inverse graphics networks, convolutional neural networks, recurrent neural networks, artificial neural networks, long/short term memory networks, gated recurrent unit networks, generative adversarial networks, liquid state machines, auto encoders, variational auto encoders, denoising auto encoders, sparse auto encoders, extreme learning machines, echo state networks, Markov chains, Hopfield networks, Boltzmann machines, restricted Boltzmann machines, deep residual networks, Kohonen networks, deep belief networks, deep convolutional networks, support vector machines, neural Turing machines, or any other suitable type or combination of neural networks without deviating from the scope of the invention.

Hidden layer 2 receives inputs from hidden layer 1, hidden layer 3 receives inputs from hidden layer 2, and so on for all hidden layers until the last hidden layer provides its outputs as inputs for the output layer. The output layer provides vector embeddings, failing radio predictions, handover issue predictions, confidence scores, etc. It should be noted that numbers of neurons I, J, K, and L are not necessarily equal, and thus, any desired number of layers may be used for a given layer of neural network 600 without deviating from the scope of the invention. Indeed, in certain embodiments, the types of neurons in a given layer may not all be the same. For instance, convolutional neurons, recurrent neurons, and/or transformer neurons may be used.

Neural network 600 is trained to assign a confidence score to appropriate outputs. In order to reduce predictions that are inaccurate, only those results with a confidence score that meets or exceeds a confidence threshold may be provided in some embodiments. For instance, if the confidence threshold is 80%, outputs with confidence scores exceeding this amount may be used and the rest may be ignored.

It should be noted that neural networks are probabilistic constructs that typically have confidence score(s). This may be a score learned by the AI/ML model based on how often a similar input was correctly identified during training. Some common types of confidence scores include a decimal number between 0 and 1 (which can be interpreted as a confidence percentage as well), a number between negative ∞ and positive ∞, a set of expressions (e.g., “low,” “medium,” and “high”), etc. Various post-processing calibration techniques may also be employed in an attempt to obtain a more accurate confidence score, such as temperature scaling, batch normalization, weight decay, negative log likelihood (NLL), etc.

“Neurons” in a neural network are implemented algorithmically as mathematical functions that are typically based on the functioning of a biological neuron. Neurons receive weighted input and have a summation and an activation function that governs whether they pass output to the next layer. This activation function may be a nonlinear thresholded activity function where nothing happens if the value is below a threshold, but then the function linearly responds above the threshold (i.e., a rectified linear unit (ReLU) nonlinearity). Summation functions and ReLU functions are used in deep learning since real neurons can have approximately similar activity functions. Via linear transforms, information can be subtracted, added, etc. In essence, neurons act as gating functions that pass output to the next layer as governed by their underlying mathematical function. In some embodiments, different functions may be used for at least some neurons.

An example of a neuron 610 is shown in FIG. 6B. Inputs x₁, x₂, . . . , xₙ from a preceding layer are assigned respective weights w₁, w₂, . . . , wₙ. Thus, the collective input from preceding neuron 1 is w₁x₁. These weighted inputs are used for the neuron's summation function modified by a bias, such as:

$${\sum }_{i = 1}^{m} ( {w}_{i} {x}_{i} ) + bias \qquad ( 1 )$$

This summation is compared against an activation function ƒ(x) to determine whether the neuron “fires”. For instance, ƒ(x) may be given by:

$$f ( x ) = \{ \begin{matrix}1 & if \sum wx + bias \geq 0 \\ 0 & if \sum wx + bias < 0\end{matrix} \qquad ( 2 )$$

The output y of neuron 610 may thus be given by:

$$y = f ( x ) {\sum }_{i = 1}^{m} ( {w}_{i} {x}_{i} ) + bias \qquad ( 3 )$$

In this case, neuron 610 is a single-layer perceptron. However, any suitable neuron type or combination of neuron types may be used without deviating from the scope of the invention. It should also be noted that the ranges of values of the weights and/or the output value(s) of the activation function may differ in some embodiments without deviating from the scope of the invention.

A goal, or “reward function,” is often employed. A reward function explores intermediate transitions and steps with both short-term and long-term rewards to guide the search of a state space and attempt to achieve a goal (e.g., finding the best core for a give service or application, determining when a network associated with a core is likely to be congested, etc.).

During training, various labeled data is fed through neural network 600. Successful identifications strengthen weights for inputs to neurons, whereas unsuccessful identifications weaken them. A cost function, such as mean square error (MSE) or gradient descent may be used to punish predictions that are slightly wrong much less than predictions that are very wrong. If the performance of the AI/ML model is not improving after a certain number of training iterations, a data scientist may modify the reward function, provide corrections of incorrect predictions, etc.

Backpropagation is a technique for optimizing synaptic weights in a feedforward neural network. Backpropagation may be used to “pop the hood” on the hidden layers of the neural network to see how much of the loss every node is responsible for, and subsequently updating the weights in such a way that minimizes the loss by giving the nodes with higher error rates lower weights, and vice versa. In other words, backpropagation allows data scientists to repeatedly adjust the weights so as to minimize the difference between actual output and desired output.

The backpropagation algorithm is mathematically founded in optimization theory. In supervised learning, training data with a known output is passed through the neural network and error is computed with a cost function from known target output, which gives the error for backpropagation. Error is computed at the output, and this error is transformed into corrections for network weights that will minimize the error.

In the case of supervised learning, an example of backpropagation is provided below. A column vector input x is processed through a series of N nonlinear activity functions ƒᵢ between each layer i=1, . . . , N of the network, with the output at a given layer first multiplied by a synaptic matrix Wᵢ, and with a bias vector bᵢ added. The network output o, given by

$$o = {f}_{N} ( {W}_{N} {f}_{N - 1} ( {W}_{N - 1} {f}_{N - 2} ( ... {f}_{1} ( {W}_{1} x + {b}_{1} ) ... ) + {b}_{N - 1} ) + {b}_{N} ) \qquad ( 4 )$$

In some embodiments, o is compared with a target output t, resulting in an

$$E = \frac{1}{2} {‖ o - t ‖}^{2} ,$$

which is desired to be minimized. error

Optimization in the form of a gradient descent procedure may be used to minimize the error by modifying the synaptic weights Wᵢ for each layer. The gradient descent procedure requires the computation of the output o given an input x corresponding to a known target output t, and producing an error o−t. This global error is then propagated backwards giving local errors for weight updates with computations similar to, but not exactly the same as, those used for forward propagation. In particular, the backpropagation step typically requires an activity function of the form pⱼ(nⱼ)=ƒⱼ^{′}(nⱼ), where nⱼ is the network activity at layer j (i.e., nⱼ=Wⱼoⱼ₋₁+bⱼ) where oⱼ=ƒⱼ(nⱼ) and the apostrophe ‘denotes the derivative of the activity function ƒ.

The weight updates may be computed via the formulae:

$${d}_{j} = \{ \begin{matrix}( o - t ) ∘ {p}_{j} ( {n}_{j} ) , & j = N \\ {W}_{j + 1}^{T} {d}_{j + 1} ∘ {p}_{j} ( {n}_{j} ) , & j < N\end{matrix} \qquad ( 5 )$$

$$\frac{\partial E}{\partial {W}_{j + 1}} = {{d}_{j + 1} ( {o}_{j} )}^{T} \qquad ( 6 )$$

$$\frac{\partial E}{\partial {b}_{j + 1}} = {d}_{j + 1} \qquad ( 7 )$$

$${W}_{j}^{new} = {W}_{j}^{old} - η \frac{\partial E}{\partial {W}_{j}} \qquad ( 8 )$$

$${b}_{j}^{new} = {b}_{j}^{old} - η \frac{\partial E}{\partial {b}_{j}} \qquad ( 9 )$$

where ° denotes ° Hadamard product (i.e., the element-wise product of two vectors), ^{T} denotes the matrix transpose, and oⱼ denotes ƒⱼ(Wⱼoⱼ₋₁+bⱼ), with o₀=x. Here, the learning rate n is chosen with respect to machine learning considerations. Below, η is related to the neural Hebbian learning mechanism used in the neural implementation. Note that the synapses W and b can be combined into one large synaptic matrix, where it is assumed that the input vector has appended ones, and extra columns representing the b synapses are subsumed to W.

The AI/ML model may be trained over multiple epochs until it reaches a good level of accuracy (e.g., 97% or better using an F2 or F4 threshold for detection and approximately 2,000 epochs). This accuracy level may be determined in some embodiments using an F1 score, an F2 score, an F4 score, or any other suitable technique without deviating from the scope of the invention. Once trained on the training data, the AI/ML model may be tested on a set of evaluation data that the AI/ML model has not encountered before. This helps to ensure that the AI/ML model is not “over fit” such that it performs well on the training data, but does not perform well on other data.

In some embodiments, it may not be known what accuracy level is possible for the AI/ML model to achieve. Accordingly, if the accuracy of the AI/ML model is starting to drop when analyzing the evaluation data (i.e., the model is performing well on the training data, but is starting to perform less well on the evaluation data), the AI/ML model may go through more epochs of training on the training data (and/or new training data). In some embodiments, the AI/ML model is only deployed if the accuracy reaches a certain level or if the accuracy of the trained AI/ML model is superior to an existing deployed AI/ML model. In certain embodiments, a collection of trained AI/ML models may be used to accomplish a task. This may collectively allow the AI/ML models to enable semantic understanding to better predict event-based congestion or service interruptions due to an accident, for instance.

Natural language processing (NLP) techniques such as word2vec, BERT, GPT-3, ChatGPT, etc. may be used in some embodiments to facilitate semantic understanding. Other techniques, such as clustering algorithms, may be used to find similarities between groups of elements. Clustering algorithms may include, but are not limited to, density-based algorithms, distribution-based algorithms, centroid-based algorithms, hierarchy-based algorithms. K-means clustering algorithms, the DBSCAN clustering algorithm, the Gaussian mixture model (GMM) algorithms, the balance iterative reducing and clustering using hierarchies (BIRCH) algorithm, etc. Such techniques may also assist with categorization.

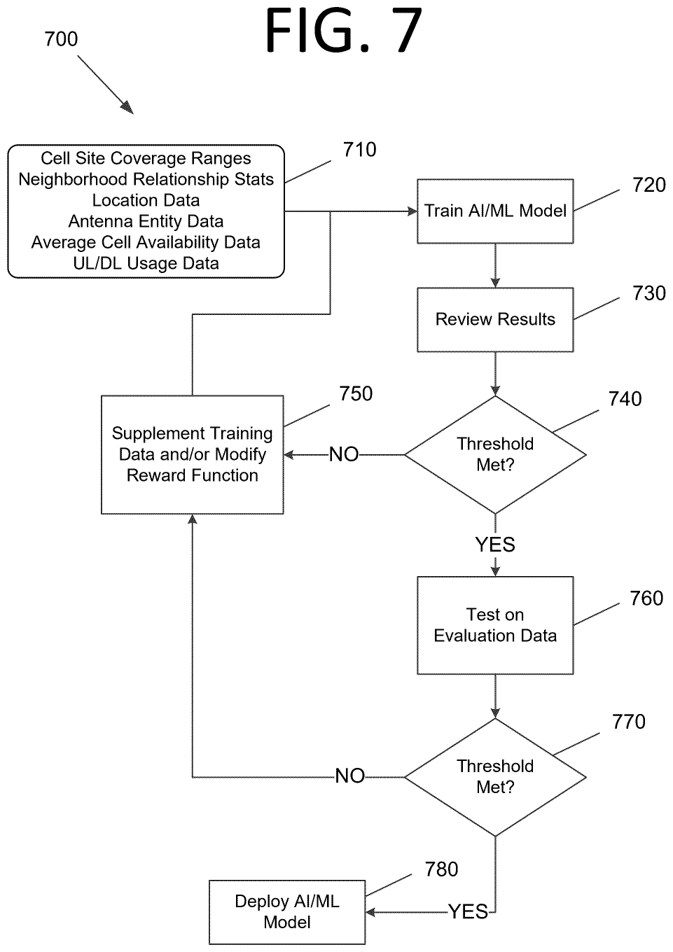

FIG. 7 is a flowchart illustrating a process 700 for training AI/ML model(s), according to an embodiment of the present invention. The process begins with providing cell site coverage ranges, neighborhood relationship statistics, location data, antenna entity data, average cell availability data, uplink and downlink usage statistics, etc. at 710, whether labeled or unlabeled. Other training data used in addition to or in lieu of the training data shown in FIG. 7. Indeed, the nature of the training data that is provided will depend on the objective that the specific AI/ML model is intended to achieve. The AI/ML model is then trained over multiple epochs at 720 and results are reviewed at 730.

If the AI/ML model fails to meet a desired confidence threshold at 740, the training data is supplemented and/or the reward function is modified to help the AI/ML model achieve its objectives better at 750 and the process returns to step 720. If the AI/ML model meets the confidence threshold at 740, the AI/ML model is tested on evaluation data at 760 to ensure that the AI/ML model generalizes well and that the AI/ML model is not over fit with respect to the training data. The evaluation data includes information that the AI/ML model has not processed before. If the confidence threshold is met at 770 for the evaluation data, the AI/ML model is deployed at 780. If not, the process returns to step 750 and the AI/ML model is trained further.

FIG. 8 is an architectural diagram illustrating a computing system 800 configured to assist with performing radio reset selection to mitigate operational impacts, according to an embodiment of the present invention. In some embodiments, computing system 800 may be one or more of the computing systems depicted and/or described herein, such as a computing system hosting a vector database, a computing system hosting an AI/ML observability platform, a computing system hosting AI/ML models, etc. In some embodiments, computing system 800 may be a computing system of a RAN, a PEDC, a BEDC, an RDC, or an NDC. Computing system 800 includes a bus 805 or other communication mechanism for communicating information, and processor(s) 810 coupled to bus 805 for processing information. Processor(s) 810 may be any type of general or specific purpose processor, including a Central Processing Unit (CPU), an Application Specific Integrated Circuit (ASIC), a Field Programmable Gate Array (FPGA), a Graphics Processing Unit (GPU), multiple instances thereof, and/or any combination thereof. Processor(s) 810 may also have multiple processing cores, and at least some of the cores may be configured to perform specific functions. Multi-parallel processing may be used in some embodiments. In certain embodiments, at least one of processor(s) 810 may be a neuromorphic circuit that includes processing elements that mimic biological neurons. In some embodiments, neuromorphic circuits may not require the typical components of a Von Neumann computing architecture.

Computing system 800 further includes a memory 815 for storing information and instructions to be executed by processor(s) 810. Memory 815 can be comprised of any combination of random access memory (RAM), read-only memory (ROM), flash memory, cache, static storage such as a magnetic or optical disk, or any other types of non-transitory computer-readable media or combinations thereof. Non-transitory computer-readable media may be any available media that can be accessed by processor(s) 810 and may include volatile media, non-volatile media, or both. The media may also be removable, non-removable, or both.

Additionally, computing system 800 includes a communication device 820, such as a transceiver, to provide access to a communications network via a wireless and/or wired connection. In some embodiments, communication device 820 may be configured to use Frequency Division Multiple Access (FDMA), Single Carrier FDMA (SC-FDMA), Time Division Multiple Access (TDMA), Code Division Multiple Access (CDMA), Orthogonal Frequency Division Multiplexing (OFDM), Orthogonal Frequency Division Multiple Access (OFDMA), Global System for Mobile (GSM) communications, General Packet Radio Service (GPRS), Universal Mobile Telecommunications System (UMTS), cdma2000, Wideband CDMA (W-CDMA), High-Speed Downlink Packet Access (HSDPA), High-Speed Uplink Packet Access (HSUPA), High-Speed Packet Access (HSPA), Long Term Evolution (LTE), LTE Advanced (LTE-A), 802.11x, Wi-Fi, Zigbee, Ultra-WideBand (UWB), 802.16x, 802.15, Home Node-B (HnB), Bluetooth, Radio Frequency Identification (RFID), Infrared Data Association (IrDA), Near-Field Communications (NFC), fifth generation (5G), New Radio (NR), any combination thereof, and/or any other currently existing or future-implemented communications standard and/or protocol without deviating from the scope of the invention. In some embodiments, communication device 820 may include one or more antennas that are singular, arrayed, phased, switched, beamforming, beamsteering, a combination thereof, and or any other antenna configuration without deviating from the scope of the invention.

Processor(s) 810 are further coupled via bus 805 to a display 825, such as a plasma display, a Liquid Crystal Display (LCD), a Light Emitting Diode (LED) display, a Field Emission Display (FED), an Organic Light Emitting Diode (OLED) display, a flexible OLED display, a flexible substrate display, a projection display, a 4K display, a high definition display, a Retina® display, an In-Plane Switching (IPS) display, or any other suitable display for displaying information to a user. Display 825 may be configured as a touch (haptic) display, a three-dimensional (3D) touch display, a multi-input touch display, a multi-touch display, etc. using resistive, capacitive, surface-acoustic wave (SAW) capacitive, infrared, optical imaging, dispersive signal technology, acoustic pulse recognition, frustrated total internal reflection, etc. Any suitable display device and haptic I/O may be used without deviating from the scope of the invention.

A keyboard 830 and a cursor control device 835, such as a computer mouse, a touchpad, etc., are further coupled to bus 805 to enable a user to interface with computing system 800. However, in certain embodiments, a physical keyboard and mouse may not be present, and the user may interact with the device solely through display 825 and/or a touchpad (not shown). Any type and combination of input devices may be used as a matter of design choice. In certain embodiments, no physical input device and/or display is present. For instance, the user may interact with computing system 800 remotely via another computing system in communication therewith, or computing system 800 may operate autonomously.

Memory 815 stores software modules that provide functionality when executed by processor(s) 810. The modules include an operating system 840 for computing system 800. The modules further include a radio analysis and reset module 845 that is configured to perform all or part of the processes described herein or derivatives thereof. Computing system 800 may include one or more additional functional modules 850 that include additional functionality.

One skilled in the art will appreciate that a “computing system” could be embodied as a server, an embedded computing system, a quantum computing system, or any other suitable computing device or combination of devices without deviating from the scope of the invention. Presenting the above-described functions as being performed by a “system” is not intended to limit the scope of the present invention in any way, but is intended to provide one example of the many embodiments of the present invention. Indeed, methods, systems, and apparatuses disclosed herein may be implemented in localized and distributed forms consistent with computing technology, including cloud computing systems. The computing system could be part of or otherwise accessible by a local area network (LAN), a mobile communications network, a satellite communications network, the Internet, a public or private cloud, a hybrid cloud, a server farm, any combination thereof, etc. Any localized or distributed architecture may be used without deviating from the scope of the invention.

It should be noted that some of the system features described in this specification have been presented as modules, in order to more particularly emphasize their implementation independence. For example, a module may be implemented as a hardware circuit comprising custom very large scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may also be at least partially implemented in software for execution by various types of processors. An identified unit of executable code may, for instance, include one or more physical or logical blocks of computer instructions that may, for instance, be organized as an object, procedure, or function. Nevertheless, the executables of an identified module need not be physically located together, but may include disparate instructions stored in different locations that, when joined logically together, comprise the module and achieve the stated purpose for the module. Further, modules may be stored on a computer-readable medium, which may be, for instance, a hard disk drive, flash device, RAM, tape, and/or any other such non-transitory computer-readable medium used to store data without deviating from the scope of the invention.

Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

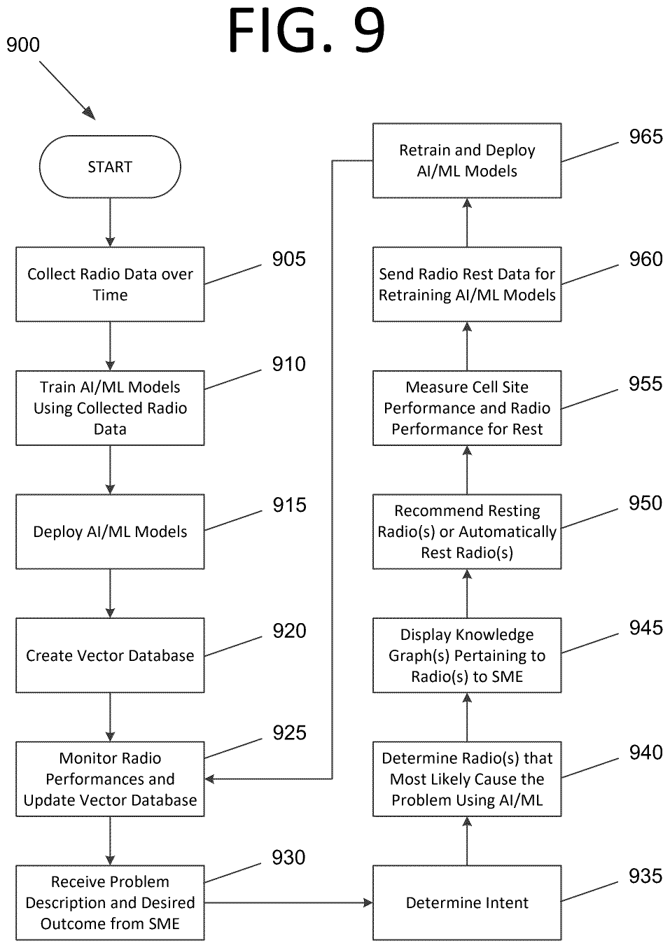

FIG. 9 is a flowchart illustrating a process 900 for performing radio reset selection to mitigate operational impacts, according to an embodiment of the present invention. The process begins with collecting radio data from various cell sites for a period of time at 905. AI/ML models (e.g., a vectorizing model, radio problem isolation model(s), etc.) are then trained using this data at 910 and deployed for use by an AI/ML observability platform at 915. The vectorizing model is used to create a vector database for radio performance characteristics at 920. Radio performances are continuously monitored and the vector database is updated with the new radio data and corresponding vector embeddings at 925.

An SME determines that a problem is occurring at a cell site and an AI observability platform receives a description of the problem and a desired outcome at 930. The AI observability platform determines the SME intent from this information at 935 (e.g., using an AI/ML model such as an LLM that has been trained to determine SME intent) and calls the AI/ML model(s) trained for radio problem isolation to determine the radio(s) that are the most likely cause of the problem at 940. For instance, the AI/ML model(s) may determine that when a value of a certain radio feature is below a certain number, the radio tends to fail and needs to be rested. The AI/ML models may also determine more complex scenarios, such as that a range of values for characteristic A is fine alone, but when coupled with another range of values for characteristic B and the presence of characteristic C, the radio tends to fail. The AI/ML model(s) may also be trained to determine an average time to failure when the radios have such characteristics so the rest can be planned accordingly. In some embodiments, knowledge graph(s) constructed from values in the vector database and pertaining to the troubled radio(s) may be displayed to the SME at 945 so he or she has a visual representation of how the radio(s) are currently operating.

Based on the output from the AI/ML model(s), the AI observability platform recommends resting the radio(s) to the SME, or automatically rests the radios itself, at 950. In some embodiments, the radio problem isolation AI/ML model(s) are trained to recommend a type of rest for of the radio(s) that are the most likely cause of the problem. The resting of the radio(s) includes performing a soft rest, performing a hard rest, or both.

The AI observability platform measures the cell site performance and performance of the radio(s) during the rest process at 955 and sends this information to the AI observability platform. The AI observability platform then sends this information (e.g., to a database with training data) for retraining the AI/ML models at 960. The AI/ML models are then retrained using this data and deployed at 965 so they can take into account the effectiveness (or ineffectiveness) of various rests. The process then returns to step 925.

The process steps performed in FIGS. 5, 7, and 9 may be performed by computer program(s), encoding instructions for the processor(s) to perform at least part of the process(es) described in FIGS. 5, 7, and 9, in accordance with embodiments of the present invention. The computer program(s) may be embodied on non-transitory computer-readable media. The computer-readable media may be, but are not limited to, a hard disk drive, a flash device, RAM, a tape, and/or any other such medium or combination of media used to store data. The computer program(s) may include encoded instructions for controlling processor(s) of computing system(s) (e.g., processor(s) 810 of computing system 800 of FIG. 8) to implement all or part of the process steps described in FIGS. 5, 7, and 9, which may also be stored on the computer-readable medium.

The computer program(s) can be implemented in hardware, software, or a hybrid implementation. The computer program(s) can be composed of modules that are in operative communication with one another, and which are designed to pass information or instructions to display. The computer program(s) can be configured to operate on a general purpose computer, an ASIC, or any other suitable device.

It will be readily understood that the components of various embodiments of the present invention, as generally described and illustrated in the figures herein, may be arranged and designed in a wide variety of different configurations. Thus, the detailed description of the embodiments of the present invention, as represented in the attached figures, is not intended to limit the scope of the invention as claimed, but is merely representative of selected embodiments of the invention.

The features, structures, or characteristics of the invention described throughout this specification may be combined in any suitable manner in one or more embodiments. For example, reference throughout this specification to “certain embodiments,” “some embodiments,” or similar language means that a particular feature, structure, or characteristic described in connection with the embodiment is included in at least one embodiment of the present invention. Thus, appearances of the phrases “in certain embodiments,” “in some embodiment,” “in other embodiments,” or similar language throughout this specification do not necessarily all refer to the same group of embodiments and the described features, structures, or characteristics may be combined in any suitable manner in one or more embodiments.

It should be noted that reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

1. One or more computing systems of a carrier network, comprising:
memory storing computer program instructions for an artificial intelligence (AI)/machine learning (ML) observability platform; and
at least one processor configured to execute the computer program instructions, wherein the computer program instructions are configured to cause the at least one processor to:
receive a problem description and a desired outcome for a cell site and determine an intent from the problem description and the desired outcome using an intent determination AI/ML model,
obtain data pertaining to one or more radios of the cell site and send the data to vectorizing AI/ML model trained to convert the data to vector embeddings, receive the vector embeddings from the vectorizing AI/ML model,
compare the vector embeddings to a vector database, and determine one or more radios that are a most likely cause of the problem using one or more radio problem isolation AI/ML models, and
recommend resting the one or more radios or automatically rest the one or more radios.

2. The one or more computing systems of claim 1, wherein the data pertaining to the one or more radios of the cell site comprises cell site coverage ranges, neighborhood relationship statistics, location data, antenna entity data, average cell availability data, uplink and downlink usage statistics, or any combination thereof.

3. The one or more computing systems of claim 1, wherein the computer program instructions are further configured to cause the at least one processor to:
collect data over a period of time from radios of a plurality of cell sites;
train the vectorizing AI/ML model and the one or more radio problem isolation AI/ML models;
deploy the vectorizing AI/ML model and the one or more radio problem isolation AI/ML models; and
create the vector database using the trained vectorizing AI/ML model.

4. The one or more computing systems of claim 1, wherein the computer program instructions are further configured to cause the at least one processor to:
continuously monitor radios from a plurality of cell sites and update the vector database using the trained vectorizing AI/ML model.

5. The one or more computing systems of claim 1, wherein the computer program instructions are further configured to cause the at least one processor to:
generate a knowledge graph for a radio of the one or more radios that are the most likely cause of the problem using the vector database; and
display the knowledge graph.

6. The one or more computing systems of claim 1, wherein the computer program instructions are further configured to cause the at least one processor to:
measure performance data of the cell site and the radios of the cell site during the resting of the one or more radios that are the most likely cause of the problem; and
send the measured performance data to a retraining database for retraining the vectorizing AI/ML model and the one or more radio problem isolation AI/ML models.

7. The one or more computing systems of claim 6, wherein the computer program instructions are further configured to cause the at least one processor to:
retrain the vectorizing AI/ML model and the one or more radio problem isolation AI/ML models using the measured performance data; and
deploy the retrained vectorizing AI/ML model and the retrained one or more radio problem isolation AI/ML models for use by the AI/ML observability platform.

8. The one or more computing systems of claim 1, wherein
the one or more radio problem isolation AI/ML models are trained to recommend a type of rest for each of the one or more radios that are the most likely cause of the problem, and
the resting of the one or more radios comprises performing a soft rest, performing a hard rest, or both.

9. One or more non-transitory computer-readable media storing one or more computer programs for an artificial intelligence (AI)/machine learning (ML) observability platform, the one or more computer programs configured to cause at least one processor to:
receive a problem description and a desired outcome for a cell site and determine an intent from the problem description and the desired outcome using an intent determination AI/ML model;
obtain data pertaining to one or more radios of the cell site and send the data to vectorizing AI/ML model trained to convert the data to vector embeddings;
receive the vector embeddings from the vectorizing AI/ML model, compare the vector embeddings to a vector database, and determine one or more radios that are a most likely cause of the problem using one or more radio problem isolation AI/ML models; and
recommend resting the one or more radios or automatically rest the one or more radios, wherein
the one or more radio problem isolation AI/ML models are trained to recommend a type of rest for each of the one or more radios that are the most likely cause of the problem, and
the resting of the one or more radios comprises performing a soft rest, performing a hard rest, or both.

10. The one or more non-transitory computer-readable media of claim 9, wherein the data pertaining to the one or more radios of the cell site comprises cell site coverage ranges, neighborhood relationship statistics, location data, antenna entity data, average cell availability data, uplink and downlink usage statistics, or any combination thereof.

11. The one or more non-transitory computer-readable media of claim 9, wherein the computer program is further configured to cause the at least one processor to:
collect data over a period of time from radios of a plurality of cell sites;
train the vectorizing AI/ML model and the one or more radio problem isolation AI/ML models;
deploy the vectorizing AI/ML model and the one or more radio problem isolation AI/ML models; and
create the vector database using the trained vectorizing AI/ML model.

12. The one or more non-transitory computer-readable media of claim 9, wherein the computer program is further configured to cause the at least one processor to:
continuously monitor radios from a plurality of cell sites and update the vector database using the trained vectorizing AI/ML model.

13. The one or more non-transitory computer-readable media of claim 9, wherein the computer program is further configured to cause the at least one processor to:
generate a knowledge graph for a radio of the one or more radios that are the most likely cause of the problem using the vector database; and
display the knowledge graph.

14. The one or more non-transitory computer-readable media of claim 9, wherein the computer program is further configured to cause the at least one processor to:
measure performance data of the cell site and the radios of the cell site during the resting of the one or more radios that are the most likely cause of the problem; and
send the measured performance data to a retraining database for retraining the vectorizing AI/ML model and the one or more radio problem isolation AI/ML models.

15. The one or more non-transitory computer-readable media of claim 14, wherein the computer program is further configured to cause the at least one processor to:
retrain the vectorizing AI/ML model and the one or more radio problem isolation AI/ML models using the measured performance data; and
deploy the retrained vectorizing AI/ML model and the retrained one or more radio problem isolation AI/ML models for use by the AI/ML observability platform.

16. A computer-implemented method for performing artificial intelligence (AI)-driven radio reset selection, comprising:
receiving a problem description and a desired outcome for a cell site and determining an intent from the problem description and the desired outcome using an intent determination AI/ML model, by a computing system;
obtaining data pertaining to one or more radios of the cell site and sending the data to vectorizing AI/ML model trained to convert the data to vector embeddings, by the computing system;
receiving the vector embeddings from the vectorizing AI/ML model,
comparing the vector embeddings to a vector database, and determining one or more radios that are a most likely cause of the problem using one or more radio problem isolation AI/ML models, by the computing system; and
recommending resting the one or more radios or automatically resting the one or more radios, by the computing system, wherein
the data pertaining to the one or more radios of the cell site comprises cell site coverage ranges, neighborhood relationship statistics, location data, antenna entity data, average cell availability data, uplink and downlink usage statistics, or any combination thereof.

17. The computer-implemented method of claim 16, further comprising:
collecting data over a period of time from radios of a plurality of cell sites, by the computing system;
training the vectorizing AI/ML model and the one or more radio problem isolation AI/ML models, by the computing system;
deploying the vectorizing AI/ML model and the one or more radio problem isolation AI/ML models, by the computing system; and
creating the vector database using the trained vectorizing AI/ML model, by the computing system.

18. The computer-implemented method of claim 16, further comprising:
continuously monitoring radios from a plurality of cell sites and update the vector database using the trained vectorizing AI/ML model, by the computing system.

19. The computer-implemented method of claim 16, further comprising:
generating a knowledge graph for a radio of the one or more radios that are the most likely cause of the problem using the vector database, by the computing system; and
displaying the knowledge graph, by the computing system or another computing system.

20. The computer-implemented method of claim 16, further comprising:
measuring performance data of the cell site and the radios of the cell site during the resting of the one or more radios that are the most likely cause of the problem, by the computing system;
sending the measured performance data to a retraining database for retraining the vectorizing AI/ML model and the one or more radio problem isolation AI/ML models, by the computing system;
retraining the vectorizing AI/ML model and the one or more radio problem isolation AI/ML models using the measured performance data, by the computing system; and
deploying the retrained vectorizing AI/ML model and the retrained one or more radio problem isolation AI/ML models, by the computing system.
